(19) United States
(12) Patent Application Publication
(10) Pub. No.: US 2009/0293017 A1
(43) Pub. Date: Nov. 26, 2009

(54) System and Method to Assist in Tagging of Entities

(75) Inventors: Bernadette Alexia Carter, Cary, NC (US); Belinda Ying-Chieh Chang, Cary, NC (US); FuYi Li, Sudbury, MA (US); Pamela Ann Nesbitt, Tampa, FL (US); Lisa Anne Seacat, San Francisco, CA (US)

Correspondence Address: Cahn & Samuels, LLP, 1100 17th St., NW, Ste. 401, Washington, DC, 20036, US

(73) Assignee: INTERNATIONAL BUSINESS MACHINES CORPORATION, Armonk, NY (US)

(21) Appl. No.: 12/126,017

(22) Filed: May 23, 2008

(51) Int. Cl. G06F 3/048

(52) U.S. Cl. 715/811

(57) ABSTRACT

A method to assist in tagging an entity includes a user selecting at least one threshold for the user's activity of at least one entity; monitoring user activity of the at least one entity; and when the at least one threshold is reached, automatically suggesting or recommending to the user that the at least one entity be tagged. The user has the option to tag or not tag the at least one entity. Usage data is associated with a tagged entity.

### I. FIELD OF THE INVENTION

This invention relates to a system and method to assist in the tagging of entities.

### II. BACKGROUND OF THE INVENTION

Tagging has become a commonplace method of keeping track of entities such as links, documents, text, images, photos, bookmarks, e-mails, sounds, or files. Usually, users manually tag entities that are important to them. In addition, users often tag entities that they use a lot. However, unless an entity is explicitly tagged, it can be difficult to find later. This means that important resources often failed to get tagged or time is wasted trying to locate entities.

A Mozilla FIREFOX® web browser plug-in may automatically tag items in a browser history. However, there remains a need to monitor user activity and automatically suggest or recommend tagging an entity based on usage of the entity. There is also a need to associate usage data with tagged entities. Accordingly, important entities are more easily tagged and searched. In addition, time is saved trying to locate such entities.

### III. SUMMARY OF THE INVENTION

According to the present invention, a method to assist in tagging an entity is provided. At least one threshold for using at least one entity is selected by a user. The user's activity of the at least one entity is monitored. When the at least one threshold is reached, it is automatically suggested or recommended to the user that the at least one entity be tagged. The user has the option to tag or not tag the at least one entity. Usage data is associated with a tagged entity.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawings, the system and methods should become evident to a person of ordinary skill in the art.

### IV. BRIEF DESCRIPTION OF THE DRAWINGS

FIG. 1 is a flowchart illustrating a method according to an embodiment of the present invention.

FIG. 2 is a block diagram of a system according to an embodiment of the present invention.

FIG. 3 is a block diagram of an exemplary agent according to an embodiment of the present invention.

### V. DETAILED DESCRIPTION OF THE DRAWINGS

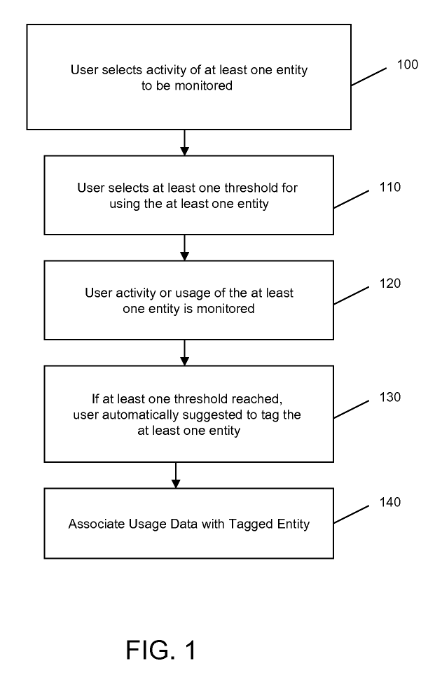

FIGS. 1-3 illustrate a system and method to assist in the tagging of entities. According to the present invention, a tagging suggestion or recommendation is automatically made based on user's usage of at least one entity, for example, a plurality of entities. Thus, the present invention helps to avoid failing to tag important resources.

A tag is a keyword or term associated with or assigned to a piece of information, thus describing the item and enabling keyword-based classification and search of information. An entity may include, but is not limited to, links, webpages, documents, text, images, photos, maps, bookmarks, e-mails, sounds, or files in a computer environment.

According to the present invention, user activity with at least one entity is monitored. User activity that may be monitored includes, but is not limited to, at least one of time spent using an entity; frequency of using an entity; pages visited the most frequently; other entities (e.g., pages) tagged; topic; or any combination thereof. In embodiments, a user may select the type of user activity that is monitored.

When a predetermined threshold for using the at least one entity is reached, tagging the at least one entity is automatically suggested or recommended to the user. In embodiments, the user may select at least one threshold, for example, time limits for using an entity (e.g., hours), number of times using an entity or visiting a page (e.g., five times), selecting topics by keywords, or the like. In embodiments, at least two thresholds, for example three or more thresholds, may be selected. Based on the monitoring of the user activity, a user is automatically prompted to tag an entity when the at least one threshold is reached. A user has the option to tag or not tag the entity.

Entities may be ranked according to usage and/or whether they exceed the at least one threshold. Accordingly, recommendations or suggestions for tagging an entity may be based upon its rank, either by usage of a single user or plurality of users. A higher ranked entity indicates that it should more likely be suggested for tagging. In embodiments, different weights may be assigned to different thresholds. In addition, usage data and ranking of entities may change based on a user's continued usage patterns. Thus, over time, usage data regarding the circumstances (e.g., what, where, when, how) of a user's activity with a tagged entity may be monitored.

According to the present invention, the usage data may be associated with tagged entities. This may be done by maintaining metadata of elements of a tag when an entity gets tagged. For example, the elements may include when the entity was tagged or where it was tagged. When a user searches for an entity, the system may return search results based on matching the current circumstance with the usage data related to a tag. In embodiments, a user can set certain search attributes to have more weight then others. For example, when users search for a tag on a work computer, they may specify that they want other tags that they tagged while at work to come up first. Over time, as a user accesses a tagged entity, metadata may be modified. For example, if users start using a link more during work hours, the search results will start to reflect that.

In embodiments, the tags of other users may be monitored. For example, if a tag of a second user matches one of the user's tags (and the user has not tagged one of the second user's entities), the system may suggest one of the second user's tagged entities as something that the user might be interested in tagging as well.

As illustrated in FIG. 1, a user selects the activity of at least one entity to be monitored 100 and at least one threshold for using the at least one entity 10 prior to an automatic tagging suggestion. For example, a user may select (1) a threshold of “3” for the number of times an entity (e.g., webpage) is visited; (2) a threshold of duration of using an entity (e.g., a webpage open for more than 2 hours); or (3) a threshold of a webpage being a top tab for more than 1 hour. The user's activity or usage of the at least one entity is monitored 120. In embodiments, the activity may be monitored by reading through cached pages and metadata or logging webpages visited. If the at least one threshold is reached (e.g., a webpage visited a third time), the user is automatically suggested or recommended to tag the at least one entity 130. Usage data is associated with any tagged entity 140. In embodiments, the suggestion may be via a pop-up window in a Graphical User Interface (GUI).

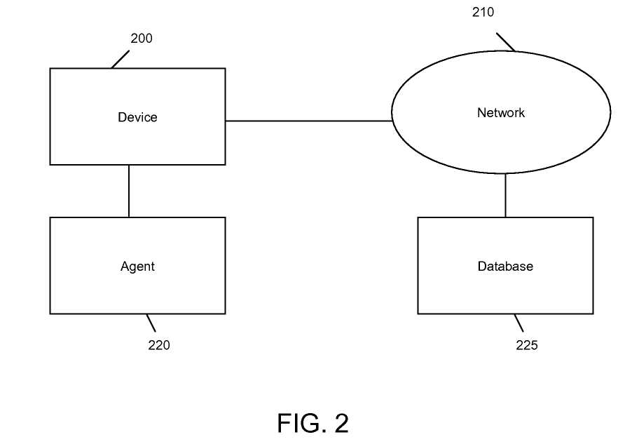

FIG. 2 is a block diagram showing an illustrative system of the invention. The illustrative system includes at least one electronic or digital device 200 (e.g., a personal computer, laptop computer, notebook computer, cellular telephone, personal digital assistant or PDA, game device, MP3 player, television). The device may be connected to a network 210 (e.g., the Internet, local area network (LAN), wide area network (WAN)). The device comprises an agent 220 for monitoring user activity of at least one entity. A database 225 may comprise a plurality of entities that a user may access and use.

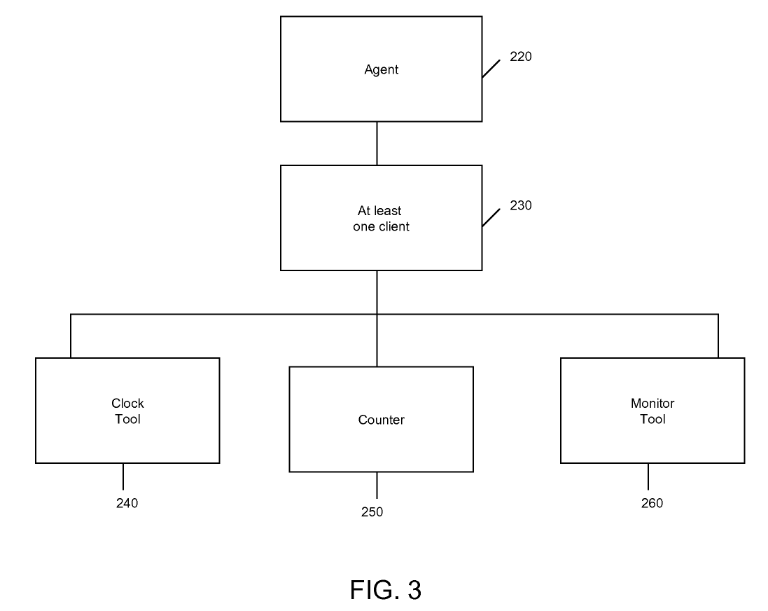

FIG. 3 illustrates an exemplary agent 220 of the invention which includes at least one client 230 comprising at least one of (1) a clock tool 240 to measure user time spent using at least one entity; (2) a counter 250 to measure a user's frequency of using at least one entity; or (3) a monitor tool 260 to monitor the tags of other users. In embodiments, the agent and its clients may be applications residing on at least one of the electronic or digital devices. The illustrative system is but one example, and one of ordinary skill in the art would recognize that many other variations may exist, all of which are contemplated by the invention.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of at least one general purpose computer, special purpose computer(s), or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. (canceled)

2. A method for assisting in tagging an entity, comprising:
selecting three thresholds for a user's activity of entities in a computer environment, said thresholds comprising time spent using an entity, frequency of using an entity, and topic;
monitoring user activity of entities in the computer environment;
when the three thresholds are reached for an entity, automatically suggesting or recommending that the user tag the entity via a graphical user interface, wherein the user tags the entity with a keyword describing the entity and enabling a keyword-based classification and search; and
associating usage data with a tagged entity including when the entity was tagged and where the entity was tagged.
